(19) United States
(12) Patent Application Publication
(10) Pub. No.: US 2014/0104212 A1
(43) Pub. Date: Apr. 17, 2014

(54) METHOD FOR DETERMINING A MOVEMENT OF A TOUCH POINT

(71) Applicant: YOMORE TECHNOLOGY CO., LTD, KAOHSIUNG CITY (TW)

(72) Inventors: Jao-Ching Lin, Taipei (TW); Wen-Ting Lee, Taipei City (TW)

(73) Assignee: YOMORE TECHNOLOGY CO., LTD, KAOHSIUNG CITY (TW)

(21) Appl. No.: 14/056,938

(22) Filed: Oct. 17, 2013

(30) Foreign Application Priority Data
Oct. 17, 2012 (TW) 101138241

(51) Int. Cl. G06F 3/0488

(52) U.S. Cl. CPC G06F 3/0488
USPC 345/173

(57) ABSTRACT

An approach is provided for a method for determining a movement of a touch point on a touch sensing device includes steps of: setting a first position of the touch point as a first center and defining a first observation zone and a first activating zone on the touch sensing device; determining whether a second position of the touch point is located in a first activating zone, setting the touch point in a quasi-activated mode when the second position of the touch point located in the first activating zone; and defining the second position of the touch point as a second center and setting a second observation zone and a second activating zone radically around the second center. The present invention dynamically sets up the second observation zone and the second activating zone according to the second position of the touch point.

### FIELD OF THE INVENTION

Embodiments of the present invention relate to a sensing method, particularly to a method for determining a movement of a touch point by dynamically adjusting determination zones.

### BACKGROUND

A touch user interface is developed as a major operation interface, is more widely applied in several kinds of electronic devices to replace conventional buttons or keys, and has characteristics of simply and conveniently operating. Therefore, customers have more fervor to purchase an electronic device with a touch sensing device.

A conventional touch sensing technique senses a movement of a touch point based on a specifically designed insensitive zone and a sensitive zone. When the touch point is located in the insensitive zone, a tiny movement of the touch point is ignored and the touch sensing device is disabled to output any position or direction information of the touch point. On the other hand, when the touch point is moved from the insensitive zone to the sensitive zone, the touch sensing device is thus turn into an activated mode that generates position or direction information of the touch point. However, an insensitive zone is seriously causing a delay to a response time of the movement of the touch point, such as an insensitive zone with wide area requires more buffering time to generate the response. An insensitive zone with narrow area, however, will be suffered with noises or vibrations. Therefore, the conventional way that operates under the insensitive zone and the sensitive zone to determine the movement of touch point, may possibly generates fault results and will delays the response time that affects controllability of the touch sensing device.

Therefore, there is a need to develop a method for determining the movement of a touch point on a touch sensing device, which is able to improve the response time or the controllability and to decrease other disadvantages in conventional way.

### SOME EXEMPLARY EMBODIMENTS

These and other needs are addressed by the present invention, wherein an approach is provided for a method for determining a movement of a touch point on a touch sensing device. The method determines the movement of the touch point by dynamically adjusting at least one determination zone to obtain the movement of the touch point and to output the corresponding direction information of the touch point.

In an aspect of the present invention, dynamically determined zones are provided according to a touch position of a touch object (i.e. finger, stylus), which is corresponding to the movement of the successive touches. The dynamic determination zones provide a quick response time and a better controllability.

In one embodiment, the method for determining a movement of touch points of the touch sensing device comprises steps of: setting a first position of the touch point as a first center and defining a first observation zone and a first activating zone on the touch sensing device; obtaining a second position of the touch point and determining whether the second position is located in the first activating zone; setting the touch sensing device in an quasi-activated mode that being able to output position or direction information when the second position of the touch point is located in the first activating zone; and defining the second position of the touch point as a second center and setting a second observation zone and a second activating zone radically around the second center when the second position of the touch point remain in the first activating zone. Notely, the touch point is determined as at an inactivated mode when the second position of the touch point is located in the first observation zone. When the touch point is moved into a sensitive zone, the touch sensing device is thus turn into an activated mode that generates position or direction information of the touch point.

In one embodiment, the second observation zone and the first observation zone have same scope. However, the second observation zone and the first observation zone have different scopes in another embodiment. A response time of the touch point relates to the scopes of the first observation zone and the second observation zone. The response time of the touch point further affects the sensitivity of the touch sensing device and by an invert relationship.

Accordingly, the present invention provides at least one determination zone in an sensing area of the touch sensing device. The determination zone is dynamically adjusted when implemented . The present invention is able to reduce a response time for determining the movement of the touch point and to increase the sensitivity and the accuracy for determining the movement of the touch point.

### BRIEF DESCRIPTION OF THE DRAWINGS

The invention is illustrated by way of example, and not for the purpose of limitation, in the figures of the accompanying drawings in which like reference numerals refer to similar elements and in which:

FIG. 1 is a schematic view showing a predetermined status of a determination zone for determining a movement of a touch point on a touch sensing device in accordance with the present invention.

FIG. 2 is a flow chart showing steps of the method for determining the movement of the touch point of the touch sensing device in accordance with the present invention.

FIG. 3A is a first status of the adjusted determination zone for determining the movement of the touch point of the touch sensing device in accordance with the present invention.

FIG. 3B is a second status of the adjusted determination zone for determining the movement of the touch point of the touch sensing device in accordance with the present invention.

### DESCRIPTION OF THE PREFERRED EMBODIMENT

A method for determining a movement of a touch point on a touch sensing device. In the following description, for the purposes of explanation, numerous specific details are set forth in order to provide a thorough understanding of the present invention. It is apparent, however, to one skilled in the art that the invention may be practiced without specific details or with an equivalent arrangement. In other instances, well-known structures and devices are shown in block diagram form in order to avoid unnecessarily obscuring the embodiments of the present invention.

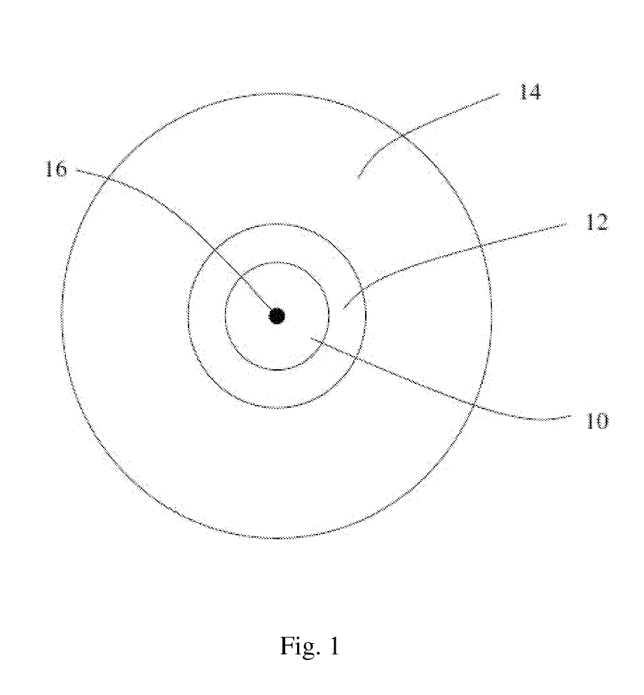

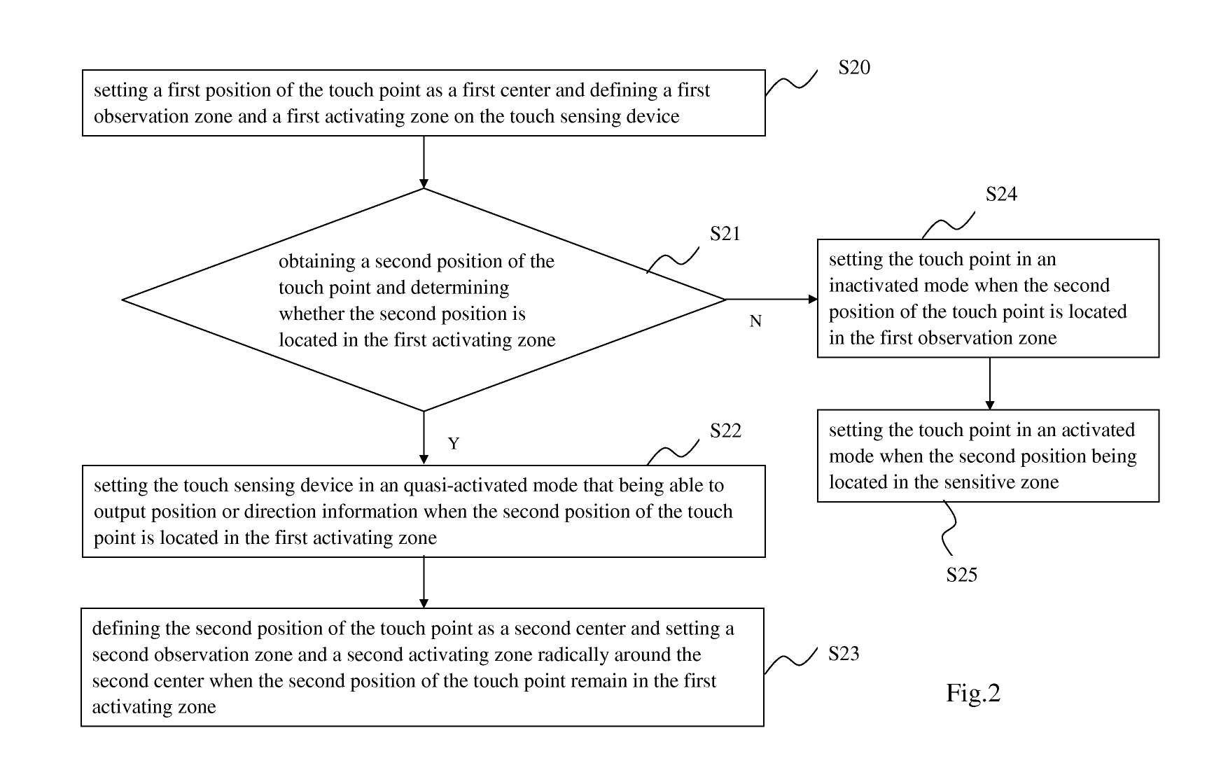

With reference to FIGS. 1 and 2, FIG. 1 is a schematic view showing a predetermined status of a method for determining a movement of a touch point on a touch sensing device in accordance with the present invention. FIG. 2 is a flow chart showing steps in the method for determining the movement of the touch point of the touch sensing device in accordance with the present invention. The method for determining the movement of the touch point of the touch sensing device is applied in a touch sensing device that comprises a first observation zone 10, a first activating zone 12 and a sensitive zone 14 sequentially and radially from a center.

In one embodiment, the method for determining the movement of the touch point of the touch sensing device comprises steps of:

S20 setting a first position of the touch point as a first center and defining a first observation zone 10 and a first activating zone 12 on the touch sensing device;

S21 obtaining a second position of the touch point 16 and determining whether the second position is located in the first activating zone 12;

S22 setting the touch sensing device in an quasi-activated mode that being able to output position or direction information when the second position of the touch point 16 is located in the first activating zone 12; and

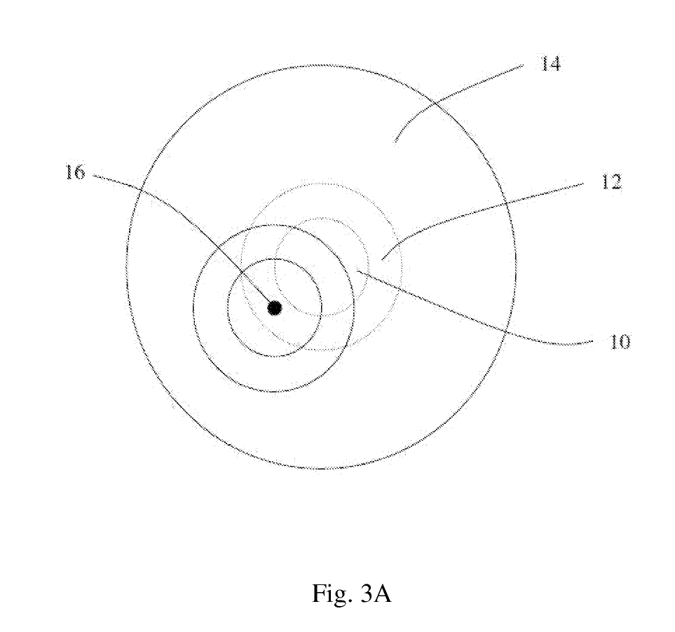

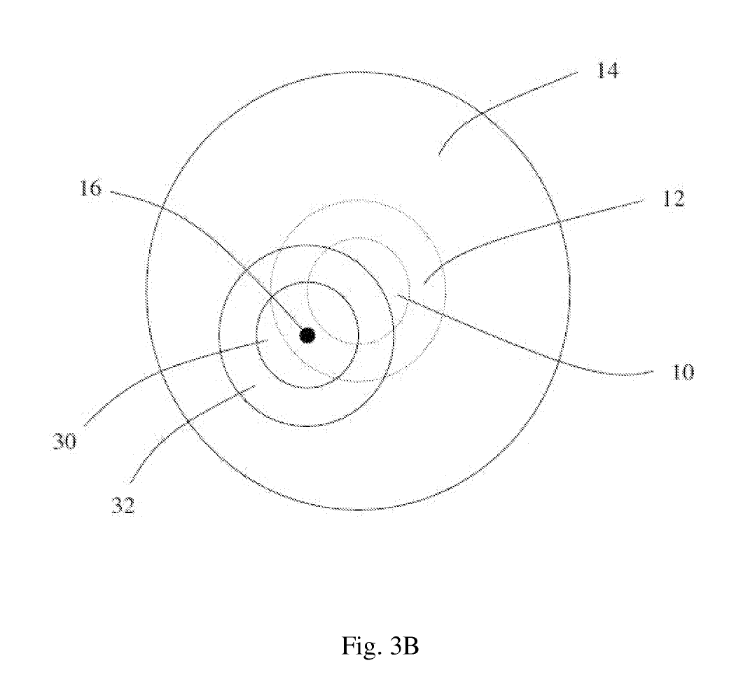

S23 defining the second position of the touch point 16 as a second center and setting a second observation zone 30 and a second activating zone 32 radically around the second center when the second position of the touch point remain in the first activating zone 12 (refer to FIGS. 3A and 3B).

The method further comprises steps of S24 setting the touch point 16 in an inactivated mode when the second position of the touch point 16 is located in the first observation zone 10.

Above mentioned second observation zone 30 and second activating zone 32, are functionally similar to the first observation zone 10 and the first activating zone 12. That is, setting the touch sensing device in an quasi-activated mode that being able to output position or direction information when a third position of the touch point 16 is located in the second observation zone 30.

In either above mentioned situation, when the touch point is moved into the sensitive zone 14, the touch sensing device is thus turn into an activated mode that generates position or direction information of the touch point.

As shown in FIGS. 1 and 2, in an embodiment, the first observation zone 10 is a circle with a specific diameter. The first activating zone 12 is a ring surrounded the central first observation zone 10. An area of the first observation zone 10 and a circumference of the first activating zone 12 have a specific ratio. The sensitive zone 14 defined around the first activating zone 12.

As shown in the step S22, when the second position of the touch point 16 being moved by a touch object (i.e. a stylus pen or a finger) or controlled by a point stick or sticks into the first activating zone 12, the touch point 16 is considered tend to move to another position and the touch sensing device is determined as the quasi-activated mode. Accordingly, this predetermined step is able to make the touch sensing device predict the touch point 16 moving to the sensitive zone 14, and thus to reduce a response time for determining the movement of the touch point 16 and to improve the response sensitivity.

In additional, with reference to FIGS. 3A and 3B, in the step S23, when the second position of the touch point remain in the first activating zone 12 defining the second position of the touch point 16 as a second center and setting a second observation zone 30 and a second activating zone 32 radically around the second center. The center of the second observation 30 is a second position of the touch point 16. Further, in the step S24, when the second position of the touch point 16 being located in the first observation zone 10, it indicates that the touch object has only a tiny offset and may not be an actual movement. The touch point 16 therefore is set as in the inactivated mode to avoid any misdetection to the dynamic movement of the touch point 16 due to excessive sensitivity.

For example, the touch object might generate tiny movement due to noise or vibration, such as during transportation. The tiny movement shows a shift/offset of the touch object but is not obvious enough to be determined as an activated mode and thus considered as the touch object is static state.

The method for determining the movement of the touch point of the touch sensing device further comprises step of S25 setting the touch point 16 in an activated mode when the second position being located in the sensitive zone 14.

In an embodiment, the second observation zone 30 and the first observation zone 10 have same area. However, the second observation zone 30 and the first observation zone 10 have different areas in another embodiment. Areas of the second observation zone 30 and the first observation zone 10 affect the response time of the touch point 16. The response time inverses with the sensitivity of the touch sensing device. For example, the touch point 16 have to move a longer distance to achieve the first activating zone 12 while the first observation zone 10 has a bigger area. Alternatively, if the first observation zone 10 has a designed smaller area, the touch point 16 might move out of the first observation zone 10 due to little offsets.

Therefore, compare with the conventional method for determining the touch point, the determination zone is dynamically adjusted when implemented. The present invention is able to reduce response time for determining the movement of the touch point and to increase the sensitivity and the accuracy for determining the movement of the touch point.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for determining a movement of a touch point on a touch sensing device comprising steps of:
setting a first position of the touch point as a first center and defining a first observation zone and a first activating zone on the touch sensing device;
obtaining a second position of the touch point and determining whether the second position is located in the first activating zone;
setting the touch sensing device in a quasi-activated mode that being able to output position or direction information when the second position of the touch point is located in the first activating zone; and
defining the second position of the touch point as a second center and setting a second observation zone and a second activating zone radically around the second center when the second position of the touch point remain in the first activating zone.

2. The method as claimed in claim 1, wherein the method further comprising step of:
setting the touch point in an inactivated mode when the second position of the touch point is located in the first observation zone.

3. The method as claimed in claim 1, wherein the method further comprising step of:
setting the touch point in the activated mode when the second position is located in the a sensitive zone.

4. The method as claimed in claim 1, wherein:
the first observation zone is a circle;
the first activating zone is a ring surrounds the first observation zone; and
the second activating zone is a ring surrounds the central second observation zone.

5. The method as claimed in claim 3, wherein the sensitive zone surrounds around the first observation zone and the first activating zone.
